(19) United States
(12) Patent Application Publication
(10) Pub. No.: US 2024/0349110 A1
(43) Pub. Date: Oct. 17, 2024

(54) BASE STATION AND COMMUNICATION METHOD

(71) Applicant: DENSO CORPORATION, Kariya-city (JP)

(72) Inventors: Tomoyuki YAMAMOTO, Kariya-city (JP); Hideaki TAKAHASHI, Kariya-city (JP)

(21) Appl. No.: 18/752,463

(22) Filed: Jun. 24, 2024

Related U.S. Application Data
(63) Continuation of application No. PCT/JP2022/047100, filed on Dec. 21, 2022.

(30) Foreign Application Priority Data
Dec. 27, 2021 (JP) 2021-212778

(51) Int. Cl. H04W 24/10

(52) U.S. Cl. CPC H04W 24/10

(57) ABSTRACT

A base station configured to operate as an MN in a case of using dual connectivity in which the MN and an SN communicate with a UE, the base station includes: configuring a plurality of measurement gap patterns in the UE; and transmitting MN configuration gap information indicating a configuration of each of the plurality of measurement gap patterns to the SN via a network interface.

### CROSS-REFERENCE TO RELATED APPLICATIONS

The present application is a continuation application of international Patent Application No. PCT/JP2022/047100, filed on Dec. 21, 2022, which designated the U.S., and claims the benefit of priority of Japanese Patent Application No. 2021-212778 (filed on Dec. 27, 2021), the entire contents of which are incorporated herein by reference.

### TECHNICAL FIELD

The present disclosure relates to a base station and a communication method used in a mobile communication system.

### BACKGROUND ART

In a 3rd Generation Partnership Project (hereinafter, 3GPP (registered trademark)) which is a mobile communication system standardization project, a “measurement gap” in which a user equipment (UE) in a radio resource control (RRC) connected state makes a temporal gap in which scheduling of data communication is not periodically performed in order to measure communication quality of non-serving cells or receive a reference signal (RS) for position estimation has been introduced. A notification of a configuration of this measurement gap pattern is given from a base station to a UE by an RRC message.

Currently, a method of configuring a plurality of measurement gap patterns in a UE so that measurement can be performed on each measurement object with an optimal gap pattern even in a case in which there are a plurality of measurement objects to be measured by the UE has been discussed in 3GPP (for example, see Non Patent Literatures 1 and 2).

A multi radio dual connectivity (MR-DC) in which a plurality of nodes using different radio access technologies (RAT) and a UE perform simultaneous communication has been mentioned as one of scenarios of configuring a plurality of measurement gap patterns in a UE. In the dual connectivity (DC), the roles of the nodes communicating with the UE are divided into a master node (MN) and a secondary node (SN), and the MN has the initiative to decide a configuration for the UE except for a configuration independently decided by the SN.

In the MR-DC, a configuration in which the MN is an evolved universal terrestrial radio access (E-UTRA) base station and the SN is an NR radio access (NR) base station is referred to as an E-UTRA NR (EN)-DC when the core network is an evolved packet core (EPC), and is referred to as an NG-RAN E-UTRA NR (NGEN)-DC when the core network is a 5th generation core network (5GC).

In the EN-DC or the NGEN-DC (hereinafter, collectively referred to as “(NG) EN-DC” as appropriate), it is assumed that the MN basically configures the measurement gap pattern in the UE, but the SN independently configures the measurement gap pattern for high frequency bands called frequency range 2 (FR2) in the UE. It has been proposed that the MN and the SN cooperate to configure the measurement gap pattern in the UE under this assumption (see Non Patent Literature 3).

### CITATION LIST

### Non Patent Literature

Non Patent Literature 1: 3GPP Contribution: “RP-211591”
Non Patent Literature 2: 3GPP Contribution: “R4-2115343”
Non Patent Literature 3: 3GPP Contribution: “R2-2109789”

### SUMMARY OF INVENTION

For example, in a case in which a plurality of measurement objects are associated with the same measurement gap pattern by the NIN and load concentration of the UE is assumed in the measurement gap pattern, it is efficient for the SN to configure, in the UE, a measurement gap pattern including a measurement gap with a timing different from that of a measurement gap pattern configured by the MIN. Alternatively, depending on the situation, there are cases in which it is preferable for the SN to configure, in the UE, a measurement gap pattern including a measurement gap with the same timing as that of the measurement gap pattern configured by the MIN.

As described above, it is considered that the SN can appropriately configure the measurement gap pattern in the UE by detecting and considering each of the measurement gap patterns configured by the MIN. However, in the current technical specification of 3GPP, a notification of only a single measurement gap pattern can be given from the MN to the SN, and the SN is unable to detect each measurement gap pattern configured by the MN.

In this regard, the present disclosure provides a base station and a communication method which are capable of appropriately configuring the measurement gap pattern in the UE even in a case in which each of the MN and the SN can configure the measurement gap pattern in the UE.

A base station according to a first feature is configured to operate as an MN in a case of using dual connectivity in which the master node (MN) and a secondary node (SN) communicate with a user equipment (UE). The base station includes: a controller configured to configure a plurality of measurement gap patterns in the UE; and a network communicator configured to transmit MN configuration gap information indicating a configuration of each of the plurality of measurement gap patterns to the SN via a network interface.

A base station according to a second feature is configured to operate as an SN in a case of using dual connectivity in which a master node (MN) and the secondary node (SN) communicate with a user equipment (UE). The base station includes: a network communicator configured to receive MN configuration gap information indicating a configuration of each of a plurality of measurement gap patterns configured in the UE by the MN from the MN via a network interface; and a controller configured to decide at least one measurement gap pattern to be configured in the UE by the SN on the basis of the MN configuration gap information.

A communication method according to a third feature is for a base station configured to operate as an MN in a case of using dual connectivity in which the master node (MN) and a secondary node (SN) communicate with a user equipment (UE). The method includes the steps of: configuring a plurality of measurement gap patterns in the UE; and transmitting MN configuration gap information indicating a configuration of each of the plurality of measurement gap patterns to the SN via a network interface.

A communication method according to a fourth feature is for a base station configured to operate as an SN in a case of using dual connectivity in which a master node (MN) and the secondary node (SN) communicate with a user equipment (UE). The method includes the steps of: receiving MN configuration gap information indicating a configuration of each of a plurality of measurement gap patterns configured in the UE by the MN from the MN via a network interface; and deciding at least one measurement gap pattern to be configured in the UE by the SN on the basis of the MN configuration gap information.

### BRIEF DESCRIPTION OF DRAWINGS

The above and other objects, features, and advantages of the present disclosure will become more apparent from the following detailed description with reference to the accompanying drawings.

FIG. 1 is a view illustrating a configuration example of a mobile communication system according to an embodiment.

FIG. 2 is a diagram illustrating a configuration example of a protocol stack of a mobile communication system according to an embodiment.

FIG. 3 is a diagram illustrating a general measurement operation.

FIG. 4 is a diagram illustrating a configuration example of an RRC message in the measurement operation of FIG. 3.

FIG. 5 is a diagram illustrating an operation in a case in which a plurality of measurement gap patterns are configured in a single UE.

FIG. 6 is a diagram illustrating a configuration example of an RRC message in the measurement operation of FIG. 5.

FIG. 7 is a diagram illustrating a configuration example of an RRC message in the measurement operation of FIG. 5.

FIG. 8 is a diagram illustrating a configuration example of an RRC message in the measurement operation of FIG. 5.

FIG. 9 is a diagram illustrating an overview of MR-DC.

FIG. 10 is a diagram illustrating an overview of MR-DC.

FIG. 11 is a diagram illustrating a configuration of a UE according to an embodiment.

FIG. 12 is a diagram illustrating a configuration of a base station according to an embodiment.

FIG. 13 is a diagram illustrating an operation example of a mobile communication system according to an embodiment.

FIG. 14 is a diagram illustrating a first configuration example of MN configuration gap information according to an embodiment.

FIG. 15 is a diagram illustrating a second configuration example of MN configuration gap information according to an embodiment.

FIG. 16 is a diagram illustrating a first modification example of the operation of the mobile communication system according to the embodiment.

FIG. 17 is a diagram illustrating a second modification example of the operation of the mobile communication system according to the embodiment.

### DESCRIPTION OF EMBODIMENTS

A mobile communication system according to an embodiment will be described with reference to the drawings. In the description of the drawings, the same or similar parts are denoted by the same or similar reference numerals.

### (Configuration of Mobile Communication System)

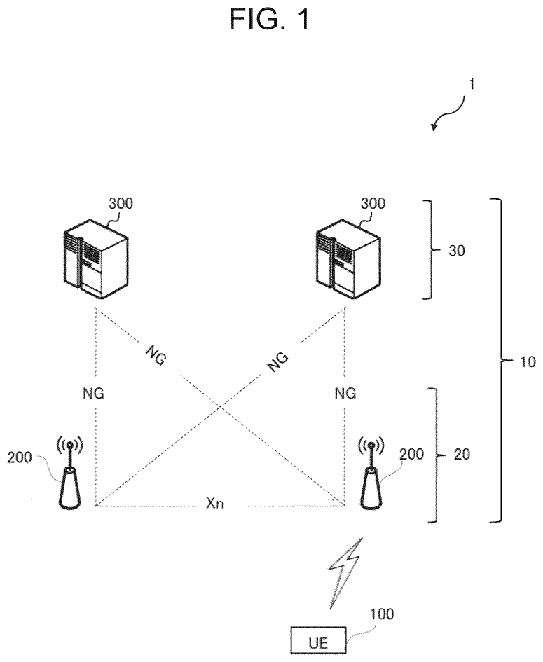

First, a configuration of a mobile communication system 1 according to an embodiment will be described with reference to FIG. 1.

The mobile communication system 1 is, for example, a system conforming to a technical specification (TS) of 3GPP. Hereinafter, a mobile communication system based on NR radio access (NR) which is a radio access technology (RAT) of a fifth generation (5G) system of 3GPP will be mainly described as the mobile communication system 1. Here, the mobile communication system 1 may have a configuration based on at least partially on evolved universal terrestrial radio access (E-UTRA)/long term evolution (LTE) which is a RAT of a fourth generation (4G) system of 3GPP.

The mobile communication system 1 includes a network 10 and a user equipment (UE) 100 that communicates with the network 10. The network 10 includes a radio access network (RAN) 20 and a core network (CN) 30. The RAN 20 is a next generation radio access network (NG-RAN) in 5G/NR. The RAN 20 may be an evolved universal terrestrial radio access network (E-UTRAN) in 4G/LTE. The CN 20 is a 5th generation core network (5GC) in 5G/NR. The CN 20 may be an evolved packet core (EPC) in 4G/LTE.

The UE 100 is an apparatus used by a user. The UE 100 is, for example, a mobile apparatus such as a mobile phone terminal such as a smartphone, a tablet terminal, a notebook personal computer (PC), a communication module, or a communication card. The UE 100 may be a vehicle (for example, a car or a train) or an apparatus provided in the vehicle. The UE 100 may be a transport body other than a vehicle (for example, a ship or an airplane) or an apparatus provided in the transport body. The UE 100 may be a sensor or an apparatus provided in the sensor. Note that the UE 100 may be referred to as another name such as a mobile station, a mobile terminal, a mobile apparatus, a mobile unit, a subscriber station, a subscriber terminal, a subscriber apparatus, a subscriber unit, a wireless station, a wireless terminal, a wireless apparatus, a wireless unit, a remote station, a remote terminal, a remote apparatus, or a remote unit.

The RAN 20 includes a plurality of base stations 200. Each of the base stations 200 manages at least one cell. A cell forms a minimum unit of a communication area. For example, one cell belongs to one frequency (a carrier frequency) and is formed by one component carrier. The term “cell” may represent a radio communication resource, and may also represent a communication target of the UE 100. Each base station 200 can perform radio communication with the UE 100 existing in its own cell. The base station 200 communicates with the UE 100 by using a protocol stack of the RAN. The base station 200 provides user plane and control plane protocol terminations towards the UE 100 and is connected to the CN 30 via a network interface between the base station and the CN. The base station 200 in 5G/NR is referred to as a gNodeB (gNB), and the base station 200 in 4G/LTE is referred to as an eNodeB (eNB). Further, the interface between the base station and the CN in 5G/NR is referred to as an NG interface, and the interface between the base station and the CN in 4G/LTE is referred to as an S1 interface. The base station 200 is connected to a neighboring base station via a network interface between base stations. An interface between base stations in 5G/NR is referred to as an Xn interface, and an interface between base stations in 4G/LTE is referred to as an X2 interface.

The CN 30 includes a core network apparatus 300. The core network apparatus 300 is an access and mobility management function (AMF) and/or a user plane function (UPF) in 5G/NR. The core network apparatus 300 may be a mobility management entity (MME) and/or a serving gateway (S-GW) in 4G/LTE. The AMF/MME performs mobility management of the UE 100. The UPF/S-GW provides a function specialized for user plane processing.

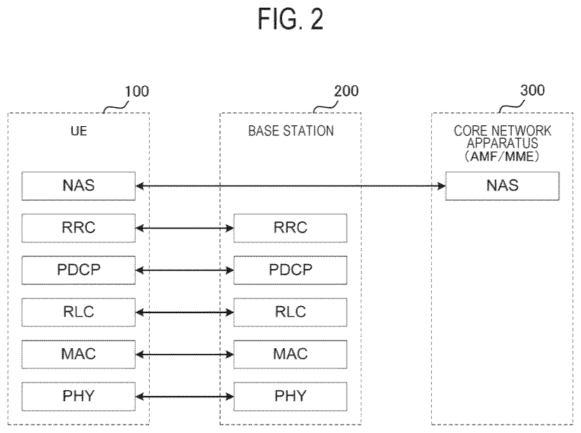

Next, a configuration example of a protocol stack in the mobile communication system 1 according to the embodiment will be described with reference to FIG. 2.

A protocol of a radio section between the UE 100 and the base station 200 includes a physical (PHY) layer, a medium access control (MAC) layer, a radio link control (RLC) layer, a packet data convergence protocol (PDCP) layer, and a radio resource control (RRC) layer.

The PHY layer performs encoding and decoding, modulation and demodulation, antenna mapping and demapping, and resource mapping and demapping. Data and control information are transmitted between the PHY layer of the UE 100 and the PHY layer of the base station 200 via a physical channel.

The physical channel includes a plurality of OFDM symbols in the time domain and a plurality of subcarriers in the frequency domain. One subframe includes a plurality of OFDM symbols in the time domain. A resource block is a resource allocation unit, and includes a plurality of OFDM symbols and a plurality of subcarriers. A frame can be composed of 10 ms, and can include 10 subframes composed of 1 ms. A number of slots corresponding to a subcarrier spacing may be included in the subframe.

Among the physical channels, a physical downlink control channel (PDCCH) plays a central role for purposes such as, for example, downlink scheduling allocation, uplink scheduling grant, and transmission power control. For example, the UE 100 performs blind decoding of the PDCCH using a cell-radio network temporary identifier (C-RNTI) and a modulation and coding scheme-C-RNTI (MCS-C-RNTI) or a configured scheduling-RNTI (CS-RNTI) allocated from the base station 200 to the UE 100, and acquires a DCI which has been successfully decoded as a DCI addressed to its own UE. Here, a cyclic redundancy check (CRC) parity bit scrambled by the C-RNTI and the MCS-C-RNTI or the CS-RNTI is added to the DCI transmitted from the base station 200.

In the NR, the UE 100 can use a bandwidth narrower than a system bandwidth (that is, the bandwidth of the cell). The base station 200 configures a bandwidth part (BWP) including consecutive PRBs in the UE 100. The UE 100 transmits and receives data and a control signal in an active BWP. In the UE 100, for example, a maximum of four BWPs can be configured. The BWPs may have different subcarrier spacings or may have frequencies overlapping each other. In a case in which a plurality of BWPs are configured for the UE 100, the base station 200 can designate which BWP is to be activated by control in downlink. As a result, the base station 200 can dynamically adjust a UE bandwidth according to the amount of data traffic of the UE 100 and the like, and can reduce the UE power consumption.

The base station 200 can configure, for example, a maximum of three control resource sets (CORESETs) in each of a maximum of four BWPs on a serving cell. The CORESET is a radio resource for control information to be received by the UE 100. A maximum of 12 CORESETs can be configured on the serving cell in the UE 100. Each CORESET has indices 0 to 11. For example, the CORESET includes 6 resource blocks (PRB) and one, two, or 3 consecutive OFDM symbols in the time domain.

The MAC layer performs priority control of data, retransmission processing by hybrid automatic repeat reQuest (hybrid ARQ (HARQ)), a random access procedure, and the like. Data and control information are transmitted between the MAC layer of the UE 100 and the MAC layer of the base station 200 via a transport channel. The MAC layer of the base station 200 includes a scheduler. The scheduler determines uplink and downlink transport formats (transport block size, and modulation and coding scheme (MCS)) and allocated resources to the UE 100.

The RLC layer transmits data to the RLC layer on a reception side by using the functions of the MAC layer and the PHY layer. Data and control information are transmitted between the RLC layer of the UE 100 and the RLC layer of the base station 200 via a logical channel.

The PDCP layer performs header compression/decompression and encryption/decryption.

A service data adaptation protocol (SDAP) layer may be provided as an upper layer of the PDCP layer. The service data adaptation protocol (SDAP) layer performs mapping between an IP flow that is a unit in which a core network performs quality of service (QoS) control, and a radio bearer that is a unit in which an access stratum (AS) performs QoS control.

The RRC layer controls the logical channel, the transport channel, and the physical channel in response to establishment, reestablishment, and release of the radio bearer. RRC signaling for various configurations is transmitted between the RRC layer of the UE 100 and the RRC layer of the base station 200. In a case in which there is an RRC connection between the RRC of the UE 100 and the RRC of the base station 200, the UE 100 is in an RRC connected state. In a case in which there is no RRC connection between the RRC of the UE 100 and the RRC of the base station 200, the UE 100 is in an RRC idle state. In a case in which an RRC connection between the RRC of the UE 100 and the RRC of the base station 200 is suspended, the UE 100 is in an RRC inactive state.

A NAS layer located above the RRC layer performs session management and mobility management of the UE 100. NAS signaling is transmitted between the NAS layer of the UE 100 and the NAS layer of the core network apparatus 300 (AMF/MME). Note that the UE 100 has an application layer and the like in addition to the radio interface protocol.

### (Overview of Measurement Operation by UE)

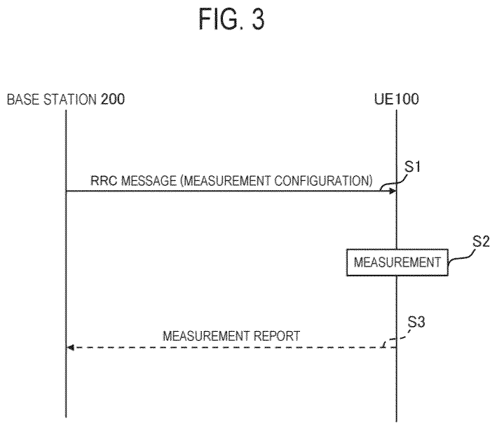

Next, an overview of a measurement operation by the UE 100 will be described with reference to FIGS. 3 to 8.

FIG. 3 is a diagram illustrating a general measurement operation. The UE 100 is in the RRC connected state. The UE 100 performs communication with the base station 200 in the serving cell managed by the base station 200.

In step S1, the base station 200 generates an RRC message including a measurement configuration for the UE 100. The RRC message is, for example, an RRC reconfiguration message, an RRC resume message, or the like, and the RRC reconfiguration message will be described below as an example. The RRC reconfiguration message is a message for changing the RRC connection.

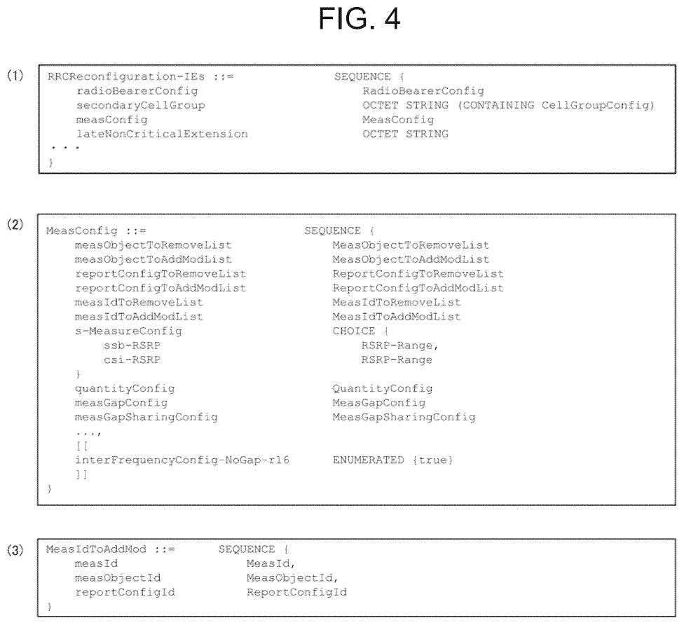

As illustrated in FIG. 4(1), the RRC message (for example, RRCReconfiguration) includes a measurement configuration (MeasConfig) that designates measurement to be performed by the UE 100.

As illustrated in FIG. 4(2), the measurement configuration (MeasConfig) includes a list of measurement objects to be added and/or changed (MeasObjectToAddModList), a list of measurement report configurations to be added and/or changed (ReportConfigToAddModList), a list of measurement identifiers to be added and/or changed (MeasIdToAddModList), and a measurement gap configuration (MeasGapConfig). In addition, the measurement configuration may include a list of measurement objects to be deleted (MeasObjectToRemoveList), a list of measurement report configurations to be deleted (ReportConfigToRemoveList), and a list of measurement identifiers to be deleted (MeasIdToRemoveList).

The list of measurement objects (MeasObjectToAddModList) may include a plurality of measurement object configurations (MeasObjectToAddMod) that designate the measurement objects. The measurement object configuration includes a set of a measurement object identifier (MeasObjectId) and measurement object information (measObject). The measurement object identifier is used to identify the measurement object configuration. The measurement object information may be, for example, information that designates a frequency, a reference signal, and the like. The reference signal may be at least one of a synchronization signal and physical broadcast channel block (SSB) constituted by a primary synchronization signal (hereinafter, PSS), a secondary synchronization signal (hereinafter, SSS), and a physical broadcast channel (PBCH), a channel state information reference signal (CSI-RS), and a positioning reference signal (PRS). The measurement object configuration includes, for example, a measurement object configuration (MeasObjectNR) that designates information applicable to SS/PBCH block intra-frequency/inter-frequency measurement and/or CSI-RS intra-frequency/inter-frequency measurement.

The list of measurement report configurations (ReportConfigToAddModList) may include a plurality of measurement report configurations (ReportConfigToAddMod). The measurement report configuration includes a set of a reporting configuration identifier (ReportConfigId) and a measurement report configuration (reportConfig). The reporting configuration identifier is used to identify a measurement reporting configuration. The measurement report configuration may designate a criterion in which a measurement result becomes a reporting trigger.

As illustrated in FIG. 4(3), the list of measurement identifiers (MeasIdToAddModList) includes a set of measurement identifier (MeasId), measurement object identifier (MeasObjectId), and reporting configuration identifier (ReportConfigId). Therefore, the measurement identifier is associated with a combination of the measurement object configuration and the measurement report configuration via the measurement object identifier and the report configuration identifier. As described above, the configurations related to the measurement object and the reporting of the measurement result are constituted with different lists, and become effective by being associated with the measurement identifier (MeasId).

The measurement gap configuration (MeasGapConfig) is used to set up and release the measurement gap pattern. The measurement gap pattern is constituted by a measurement gap capable of interrupting communication. The measurement gap configuration includes gapOffset, mgl, mgrp, and mgta. mgl is a measurement gap length (measurement gap length) of the measurement gap. mgrp is a measurement gap repetition period (MGRP) of the measurement gap. mgta is measurement gap timing advance (measurement gap timing advance). gapOffset is a gap offset of the measurement gap pattern associated with MGRP.

Referring back to FIG. 3, in step S2, the UE 100 that has received the RRC message performs measurement on the measurement object on the basis of the measurement configuration included in the received RRC message. Here, the UE 100 performs measurement on the measurement object configured on the basis of the measurement object configuration during the measurement gap configured on the basis of the measurement gap configuration.

In step S3, the UE 100 transmits a measurement report including the measurement result in step S2 to the base station 200. The UE 100 transmits the measurement report to the base station 200 in a case in which the measurement report is triggered on the basis of the measurement report configuration. The base station 200 receives the measurement report from the UE 100.

In recent years, there has been discussed a method of configuring a plurality of measurement gap patterns in the UE 100 so that measurement can be performed on each measurement object with an optimal measurement gap pattern even in a case in which there are a plurality of measurement objects to be measured by the UE 100. A case in which a plurality of measurement gap pattern configurations are present in a single UE 100 may be referred to as “multiple concurrent and independent MG patterns”.

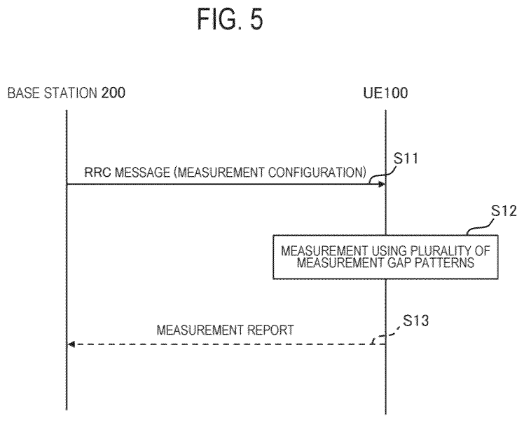

FIG. 5 is a diagram illustrating an operation of configuring a plurality of measurement gap patterns in a single UE 100. Here, the description will proceed mainly with differences from the above-described general measurement operation.

As illustrated in FIG. 5, in step S11, the base station 200 transmits the RRC message to the UE 100.

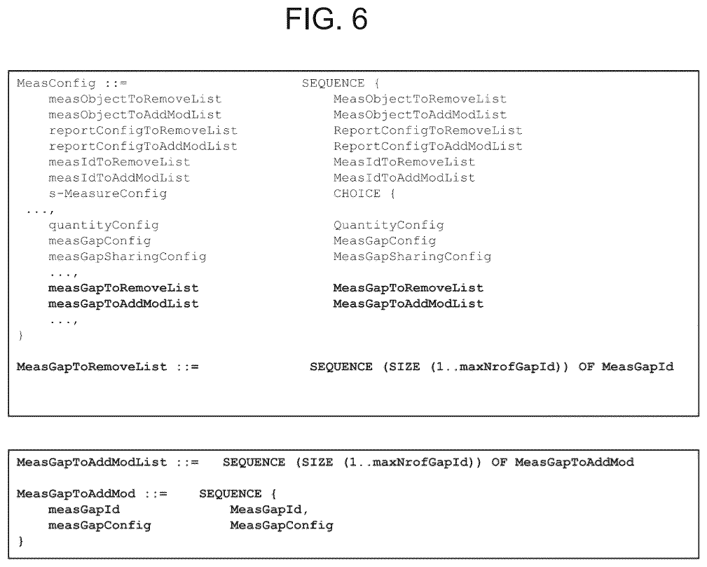

As illustrated in FIG. 6, the measurement configuration (MeasConfig) included in the RRC message includes a list of measurement gap configurations (MeasGapToAddModList) to be added and/or changed. The measurement configuration may include a list of measurement gap identifiers (MeasGapToRemoveList) to be deleted.

The list of measurement gap configurations (MeasGapToAddModList) includes a set (MeasGapToAddMod) of measurement gap identifier (MeasGapId) and a plurality of measurement gap configurations (MeasGapConfig). The measurement gap identifier is used to identify the measurement gap configuration (measurement gap pattern).

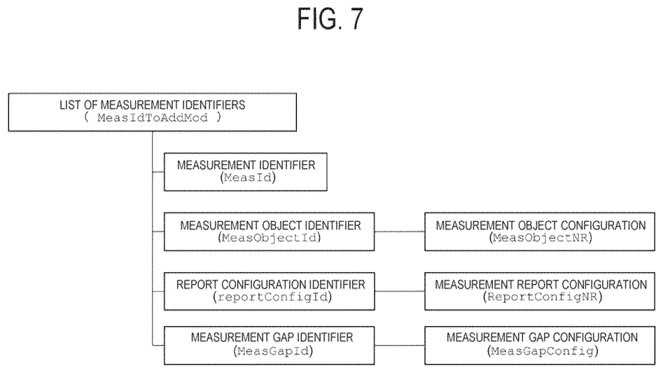

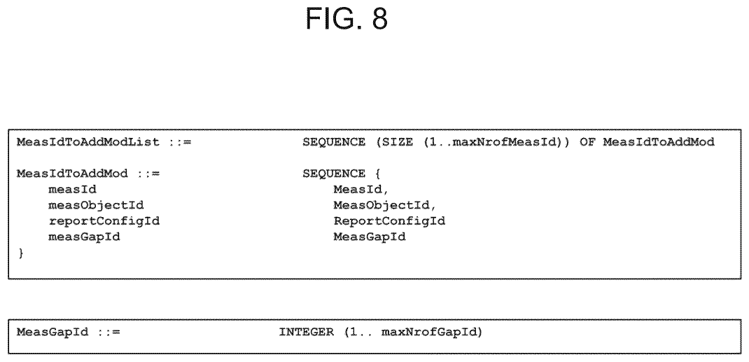

Further, the RRC message includes a set of measurement identifier and measurement gap identifier. As illustrated in FIGS. 7 and 8, the list of measurement identifies (MeasIdToAddMod) includes a set (MeasIdToAddMod) of measurement identifier (MeasId) and measurement gap identifier (MeasGapId). The set further includes the measurement object identifier (MeasObjectId) and the report configuration identifier (reportConfigId). Accordingly, the measurement gap identifier is associated with the measurement identifier. As a result, each of a plurality of measurement configurations is associated with the measurement identifier via the measurement gap identifier.

As illustrated in FIG. 6, the measurement configuration may include an existing measurement gap configuration (MeasGapConfig), separately from the list of measurement gap configurations. The existing measurement gap configuration may be dealt as one of a plurality of measurement gap configurations. The measurement gap configurations in the list of measurement gap configurations may be dealt as a second or subsequent measurement gap configuration. Alternatively, the existing measurement gap configuration may become unavailable in a case in which a list of measurement gap configurations is included in the RRC message. In addition, the existing measurement gap configuration may be used only in a case in which the UE 100 does not support the configuration of a plurality of gap patterns. In a case in which the UE 100 supports the configuration of a plurality of gap patterns, the existing measurement gap configuration may become unavailable.

Further, the base station 200 associates the measurement gap configuration with the measurement identifier such that each frequency layer is associated with only one gap pattern. In a case in which the reference signals (for example, SSB, CSI-RS, PRS) serving as the measurement object are different even in the same frequency layer, the reference signals may be dealt as different frequency layers.

Referring back to FIG. 5, in step S12, the UE 100 that has received the RRC message performs measurement on the measurement object. Specifically, the UE 100 performs measurement on the measurement object configured on the basis of the measurement object configuration during the measurement gap of a plurality of measurement gap patterns configured on the basis of a plurality of measurement gap configurations. As described above, the UE 100 configures a plurality of gap patterns on the basis of a plurality of measurement gap configurations. Specifically, in a case in which measurement is performed on a predetermined measurement object, the UE 100 performs the measurement using the measurement gap pattern based on the measurement gap configuration associated with the measurement identifier associated with the predetermined measurement object. Here, the UE 100 performs measurement on the measurement object based on the measurement object configuration associated with the measurement identifier via the measurement object identifier using the measurement gap pattern based on the measurement gap configuration associated with the measurement identifier via the measurement gap identifier.

In step S13, the UE 100 transmits a measurement report including the measurement result in step S12 to the base station 200. The UE 100 transmits the measurement report to the base station 200 in a case in which the measurement report is triggered on the basis of the measurement report configuration. The base station 200 receives the measurement report from the UE 100.

### (Overview of MR-DC)

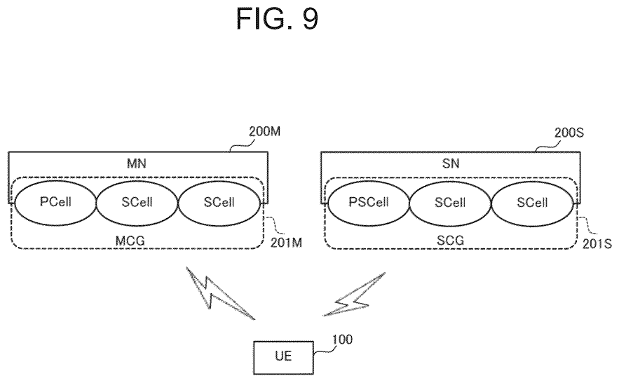

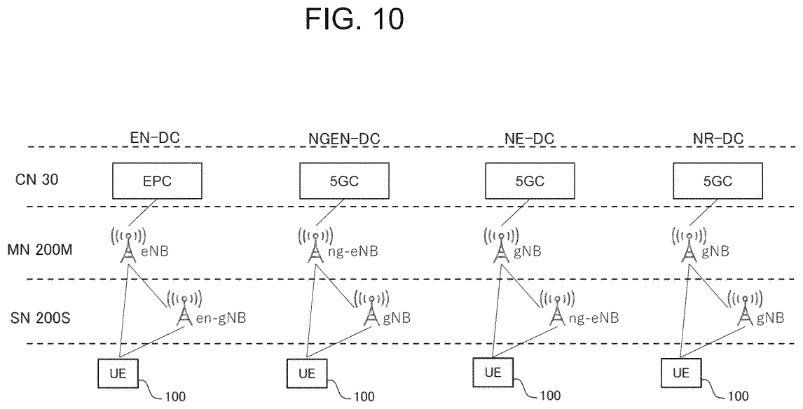

Next, an overview of the MR-DC will be described with reference to FIGS. 9 and 10.

As illustrated in FIG. 9, in the MR-DC, the UE 100 performs simultaneous communication with a master cell group (MCG) 201M managed by a master node (MN) 200M and a secondary cell group (SCG) 201S managed by a secondary node (SN) 200S. The MN 200M may be an NR base station (gNB) or an LTE base station (eNB). The MN 200M is also referred to as a master base station. An SN 200S may be an NR base station (gNB) or an LTE base station (eNB). The SN 200S is also referred to as a secondary base station.

For example, the MN 200M transmits a predetermined message (for example, an SN addition request message) to the SN 200S, and the MN 200M transmits an RRC reconfiguration message to the UE 100, so that the DC is initiated.

The UE 100 in the RRC connected state is allocated radio resources from schedulers of the MN 200M and the SN 200S connected to each other via a network interface, and performs radio communication by using the radio resources of the MN 200M and the radio resources of the SN 200S. The network interface between the MN 200M and the SN 200 may be an Xn interface or an X2 interface. The MN 200M and the SN 200 communicate with each other via the network interface.

The MN 200M may have a control plane connection with the core network. The MN 200M provides main radio resources of the UE 100. The MN 200M manages the MCG 201M. The MCG 201M is a group of serving cells associated with the MN 200M. The MCG 201M includes a primary cell (PCell), and optionally includes one or more secondary cells (SCells).

The SN 200S may not have a control plane connection with the core network. The SN 200S provides additional radio resources to the UE 100. The SN 200S manages the SCG 201S. The SCG 201S includes a primary secondary cell (PSCell), and optionally includes one or more SCells. Note that the PCell of the MCG 201M and the PSCell of the SCG 201S are also referred to as special cells (SpCells).

As described above, in the DC (MR-DC), the roles of the nodes communicating with the UE 100 are divided into the MN 200M and the SN 200S, and the MN 200M has the initiative to decide the configuration for the UE 100 except for the configuration independently decided in the SN 200S.

As illustrated in FIG. 10, in the MR-DC, a configuration in which the MN 200M is an E-UTRA base station and the SN 200S is an NR base station is referred to as (NG) EN-DC. Specifically, in a case in which the CN 30 is an EPC, a configuration in which the MN 200M is an E-UTRA base station (eNB) and the SN 200S is an NR base station (en-gNB) is referred to as EN-DC. Further, in a case in which the CN 30 is 5GC, a configuration in which the MN 200M is an E-UTRA base station (ng-eNB) and the SN 200S is an NR base station (gNB) is referred to as NGEN-DC.

In a case in which the CN 30 is 5GC, a configuration in which the MN 200M is an NR base station (gNB) and the SN 200S is an E-UTRA base station (ng-eNB) is referred to as NE-DC. Further, in a case in which the CN 30 is 5GC, a configuration in which the MN 200M is an NR base station (gNB) and the SN 200S is also an NR base station (gNB) is referred to as NR-DC.

In the (NG) EN-DC, it is assumed that the MN 200M basically configures the measurement gap pattern in the UE 100, but the SN 200S independently configures the measurement gap pattern for high frequency bands called frequency range 2 (FR2) in the UE 100.

For example, in a case in which a plurality of measurement objects are associated with the same measurement gap pattern by the MN 200M and load concentration of the UE 100 is assumed in the measurement gap pattern, it is efficient for the SN 200S to configure, in the UE 100, a measurement gap pattern including a measurement gap having a timing different from that of a measurement gap pattern configured by the MN 200M. Alternatively, depending on a situation, there are cases in which it is preferable for the SN 200S to configure, in the UE 100, a measurement gap pattern including a measurement gap with the same timing as that of the measurement gap pattern configured by the MN 200M. As described above, it is considered that the SN 200S can appropriately configure the measurement gap pattern in the UE 100 by detecting and considering each of the measurement gap patterns configured by the MN 200M.

The following description will proceed mainly with a scenario (multiple concurrent and independent MG patterns) in which a plurality of measurement gap patterns are configured in the UE 100 on the assumption that the (NG) EN-DC is applied.

### (Configuration of User Equipment)

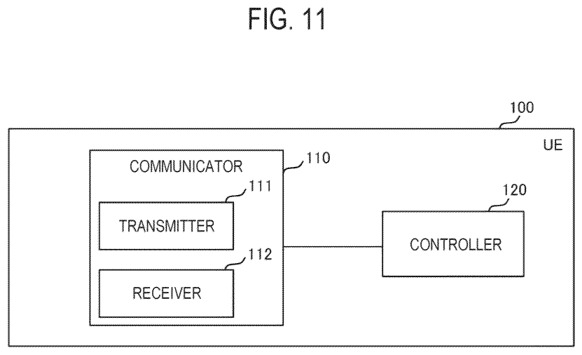

Next, a configuration of the UE 100 according to an embodiment will be described with reference to FIG. 11. The UE 100 includes a communicator 110 and a controller 120.

The communicator 110 performs radio communication with the base station 200 by transmitting and receiving a radio signal to and from the base station 200. The communicator 110 includes at least one transmitter 111 and at least one receiver 112. The transmitter 111 and the receiver 112 may include a plurality of antennas and RF circuits. The antenna converts a signal into a radio wave and emits the radio wave into space. Further, the antenna receives a radio wave in space and converts the radio wave into a signal. The RF circuit performs analog processing of a signal transmitted and received via the antenna. The RF circuit may include a high frequency filter, an amplifier, a modulator, a low pass filter, and the like.

The controller 120 performs various types of control in the UE 100. The controller 120 controls communication with the base station 200 via the communicator 110. The operation of the UE 100 described above and described later may be an operation under the control of the controller 120. The controller 120 may include at least one processor capable of executing a program and a memory that stores the program. The processor may execute the program to perform the operation of the controller 120. The controller 120 may include a digital signal processor that executes digital processing of the signal transmitted and received via the antenna and the RF circuit. The digital processing includes processing of the protocol stack of the RAN. Further, the memory stores a program executed by the processor, parameters related to the program, and data related to the program. The memory may include at least one of a read only memory (ROM), an erasable programmable read only memory (EPROM), an electrically erasable programmable read only memory (EEPROM), a random access memory (RAM), and a flash memory. All or part of the memory may be included in the processor.

In the UE 100 configured as described above, the communicator 110 receives, from the base station 200, an RRC message including a plurality of measurement gap configurations for configuring a plurality of measurement gap patterns constituted by the measurement gaps capable of interrupting communication. The controller 120 performs measurement on the measurement object during the measurement gap configured on the basis of a plurality of measurement gap configurations. In the RRC message, each of a plurality of measurement gap configurations is associated with at least one measurement identifier associated with a combination of the measurement object configuration and the measurement report configuration. The controller 120 performs the measurement based on the measurement object configuration associated with the measurement identifier during the measurement gap constituting the measurement gap pattern based on the measurement gap configuration associated with the measurement identifier.

In the embodiment, the communicator 110 can receive the RRC message for configuring the measurement gap pattern from each of the MN 200M and the SN 200S. That is, the measurement gap pattern can be configured from each of the MN 200M and the SN 200S in UE 100. The UE 100 (controller 120) performs measurement on the measurement object during each measurement gap in each measurement gap pattern configured from each of the MN 200M and the SN 200S.

### (Configuration of Base Station)

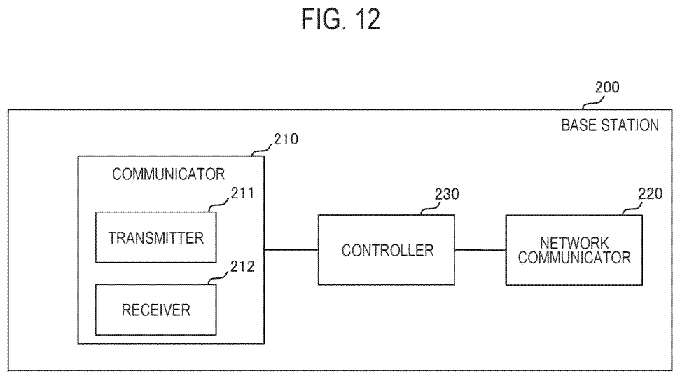

Next, a configuration of the base station 200 according to an embodiment will be described with reference to FIG. 12. The base station 200 includes a communicator 210, a network communicator 220, and a controller 230.

For example, the communicator 210 receives a radio signal from the UE 100 and transmits a radio signal to the UE 100. The communicator 210 includes at least one transmitter 211 and at least one receiver 212. The transmitter 211 and the receiver 212 may include an RF circuit. The RF circuit performs analog processing of a signal transmitted and received via the antenna. The RF circuit may include a high frequency filter, an amplifier, a modulator, a low pass filter, and the like.

The network communicator 220 transmits and receives signals to and from the network. The network communicator 220 receives, for example, a signal from a neighboring base station connected via the Xn interface or the X2 interface, which is an interface between base stations, and transmits the signal to the neighboring base station. In addition, the network communicator 220 receives, for example, a signal from the core network apparatus 300 connected via the NG interface or the S1 interface, and transmits the signal to the core network apparatus 300.

The controller 230 performs various types of control in the base station 200. The controller 230 controls, for example, communication with the UE 100 via the communicator 210. Further, the controller 230 controls, for example, communication with a node (for example, the neighboring base station and the core network apparatus 300) via the network communicator 220. The operation of the base station 200 described above and described later may be an operation under the control of the controller 230. The controller 230 may include at least one processor capable of executing a program and a memory that stores the program. The processor may execute the program to perform the operation of the controller 230. The controller 230 may include a digital signal processor that executes digital processing of a signal transmitted and received via the antenna and the RF circuit. The digital processing includes processing of the protocol stack of the RAN. Further, the memory stores a program executed by the processor, parameters related to the program, and data related to the program. All or part of the memory may be included in the processor.

The base station 200 configured as described above may operate as the MN 200M in a case in which the MR-DC is used. Specifically, the base station 200 may be an E-UTRA base station operating as the MN 200M in the (NG) EN-DC. In this base station 200, the controller 230 configures a plurality of measurement gap patterns in the UE 100. The network communicator 220 transmits the MN configuration gap information indicating the configuration of each of a plurality of measurement gap patterns to the SN 200S via the network interface. Accordingly, even in a case in which each of the MN 200M and the SN 200S can configure the measurement gap pattern in the UE 100, the SN 200S can detect and consider each measurement gap pattern configured by the MN 200M. Therefore, the SN 200S can appropriately configure the measurement gap pattern in the UE 100.

Alternatively, the base station 200 may operate as the SN 200S in a case in which the MR-DC is used. Specifically, the base station 200 may be an NR base station that operates as the SN 200S in the (NG) EN-DC. In this base station 200, the network communicator 220 receives the MN configuration gap information indicating the configuration of each of a plurality of measurement gap patterns configured in the UE 100 by the MN 200M from the MN 200M via the network interface. The controller 230 decides at least one measurement gap pattern configured in the UE 100 by the SN 200S on the basis of the MN configuration gap information. Accordingly, even in a case in which each of the MN 200M and the SN 200S can configure the measurement gap pattern in the UE 100, the SN 200S can appropriately configure the measurement gap pattern in the UE 100 by detecting and considering each measurement gap pattern configured by the MN 200M.

### (Operation Example of Mobile Communication System)

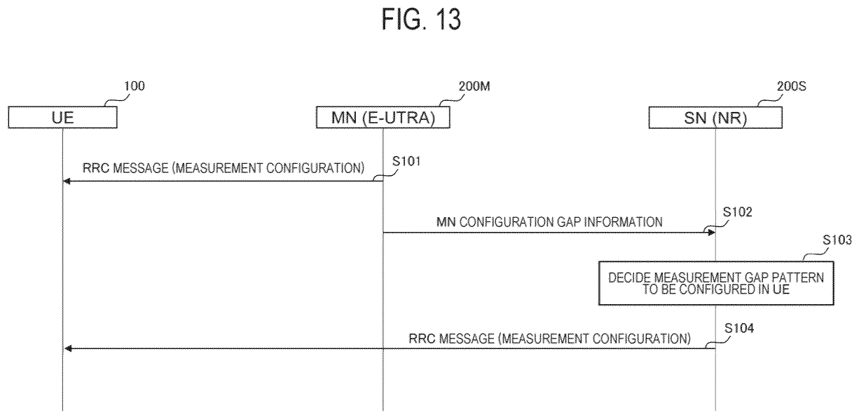

Next, an operation of the mobile communication system 1 according to the embodiment will be described with reference to FIGS. 13 to 15.

FIG. 13 is a diagram illustrating an operation example of the mobile communication system 1 according to an embodiment.

In step S101, the MN 200M (transmitter 211) transmits the RRC message including the measurement configuration for configuring a plurality of measurement gap patterns to the UE 100. For example, the measurement gap pattern configured in the UE 100 by the MN 200M may be a measurement gap pattern for a purpose (object) other than FR2. The “purpose” of the measurement gap pattern may be referred to as a “use case” of the measurement gap pattern.

In step S102, the MN 200M (network communicator 220) transmits the MN configuration gap information indicating the configuration of each measurement gap pattern configured in the UE 100 in step S101 to the SN 200S via the network interface (specifically, the interface between the base stations). The SN 200S (network communicator 220) receives the MN configuration gap information.

The MN configuration gap information is constituted by an information element included in a message between the base stations transmitted on the interface between the base stations. The message between the base stations may be an SN addition request message for adding the SN 200S when initiating the DC, or an SN correction request message for correcting the configuration of the SN 200S after initiating the DC. The information element constituting the MN configuration gap information may be CG-ConfigInfo which is a type of RRC message between nodes and used for establishing or changing the SCG, or may be an information element which is newly introduced into the message between the base stations. Hereinafter, the description will proceed mainly with an example in which the information element constituting the gap upper limit information is the CG-ConfigInfo.

In step S103, the SN 200S (controller 230) decides at least one measurement gap pattern, which is configured in the UE 100 by the SN 200S, on the basis of the MN configuration gap information received in step S102. For example, in a case in which a plurality of measurement objects are associated with the same measurement gap pattern by the MN 200M and load concentration of the UE 100 is assumed in the measurement gap, the SN 200S (controller 230) may make a decision to configure, in the UE 100, the measurement gap pattern including the measurement gap with a timing different from that of the measurement gap pattern configured by the MN 200M. Alternatively, in a case in which the SN 200S desires to use the measurement gap pattern configured by the MN 200M as in a modification example to be described later, a decision to configure, in the UE 100, the same measurement gap pattern as the measurement gap pattern configured by the MN 200M may be made.

In step S104, the SN 200S (transmitter 211) transmits the RRC message including the measurement configuration for configuring the measurement gap pattern decided in step S103 to the UE 100. For example, the measurement gap pattern configured in the UE 100 by the SN 200S may be a measurement gap pattern for the purpose (object) of FR2.

As described above, according to the embodiment, the SN 200S can detect a plurality of measurement gap patterns configured by the MN 200M. Therefore, depending on a situation, it is possible to secure optimal performance by causing the timing of the measurement gap of the measurement gap pattern configured by the SN 200S to overlap or be shifted from the measurement gap pattern configured by the MN 200M.

### (1) First Configuration Example of MN Configuration Gap Information

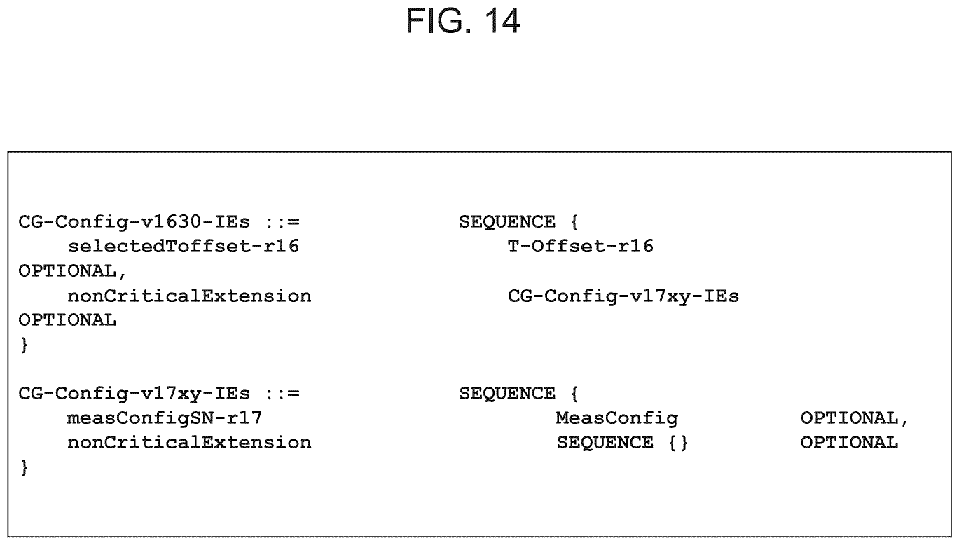

FIG. 14 is a diagram illustrating a first configuration example of the MN configuration gap information according to the embodiment.

As described above, the MN 200M (transmitter 211) transmits the RRC message including the measurement configuration for configuring a plurality of measurement gap patterns to the UE 100. In the present configuration example, the MN 200M (network communicator 220) transmits the measurement configuration transmitted to the UE 100 to the SN 200S as the MN configuration gap information. The SN 200S (network communicator 220) receives the measurement configuration transmitted from the MN 200M to the UE 100 as the MN configuration gap information from the MN 200M. Accordingly, the SN 200S detects the overall measurement configuration including a plurality of measurement gap patterns transmitted from the MN 200M to the UE 100. Therefore, the SN 200S can appropriately configure the measurement gap pattern in the UE 100.

As illustrated in FIG. 14, CG-ConfigInfo transmitted from the MN 200M to the SN 200S includes “CG-Config-v17xy-IEs” associated with the MN configuration gap information indicating the configuration of each measurement gap pattern configured in the UE 100. “CG-Config-v17xy-IEs” includes the measurement configuration (MeasConfig) configured in the UE 100 by the MN 200M.

### (2) Second Configuration Example of MN Configuration Gap Information

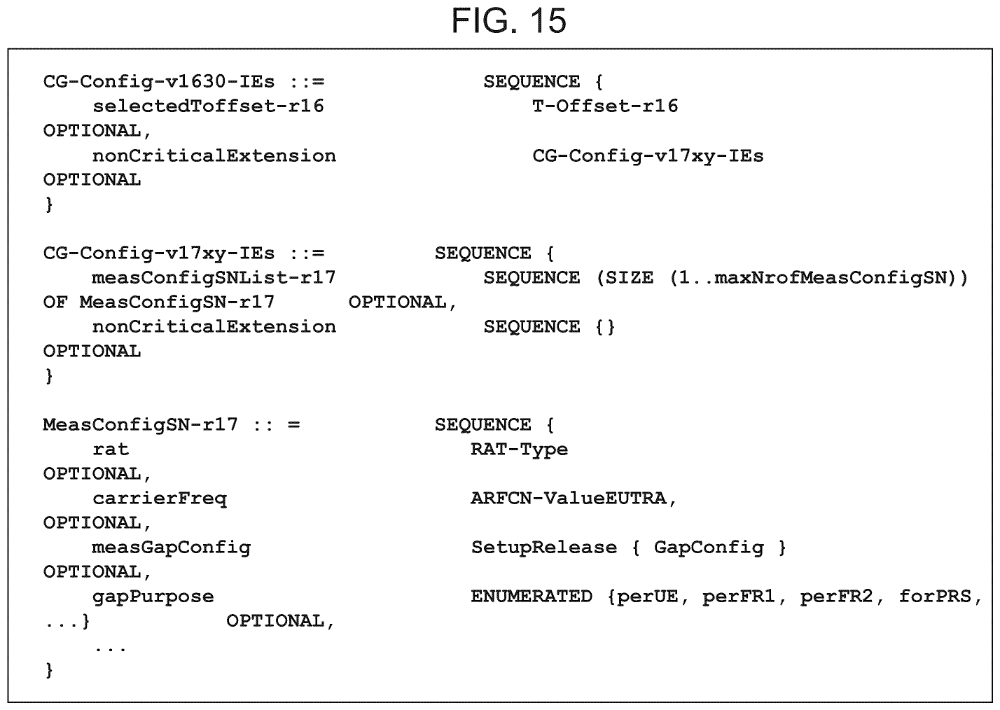

FIG. 15 is a diagram illustrating a second configuration example of the MN configuration gap information according to the embodiment.

In the present configuration, the MN 200M (network communicator 220) transmits, to the SN 200S as the MN configuration gap information, configuration information which is information of a part of the measurement configuration (MeasConfig) transmitted to the UE 100, and dedicated to each of a plurality of measurement gap patterns configured in the UE 100 by the MN 200M. That is, the MN 200M (network communicator 220) transmits, to the SN 200S as the MN configuration gap information, an information element obtained by extracting only minimum necessary information for the SN 200S to configure the measurement gap pattern out of the information included in MeasConfig. The SN 200S (network communicator 220) receives, from the MN 200M as the MN configuration gap information, configuration information which is information of the part of the measurement configuration transmitted from the MN 200M to the UE 100, and dedicated to each of a plurality of measurement gap patterns. Accordingly, the size (message size) of the MN configuration gap information can be reduced as compared to the above-described first configuration example.

As illustrated in FIG. 15, CG-ConfigInfo transmitted from the MN 200M to the SN 200S includes “CG-Config-v17xy-IEs” associated with the MN configuration gap information indicating the configuration of each measurement gap pattern configured in the UE 100. “CG-Config-v17xy-IEs” includes “measConfigSNList-r17”, which is a new information element in which “MeasConfigSN-r17” serving as configuration information dedicated to each measurement gap pattern configured in the UE 100 by the MN 200M is listed. “MeasConfigSN-r17” includes, as the parameter of the associated measurement gap pattern, at least one information element among “RAT-Type” indicating a type of RAT, “ARFCN-ValueEUTRA” indicating a carrier frequency, the measurement gap configuration “measGapConfig”, and “gapPurpose” indicating the purpose (object) of the measurement gap pattern. For “gapPurpose”, for example, set is any one of “perUE” which is a measurement gap pattern configured in units of UEs, “perFR1” indicating that a frequency range 1 (FR1) is set as an object, “perFR2” indicating that a frequency range 2 (FR2) is set as an object, and “forPRS” indicating that a positioning reference signal (PRS) is set as an object.

### (First Modification Example of Operation of Mobile Communication System)

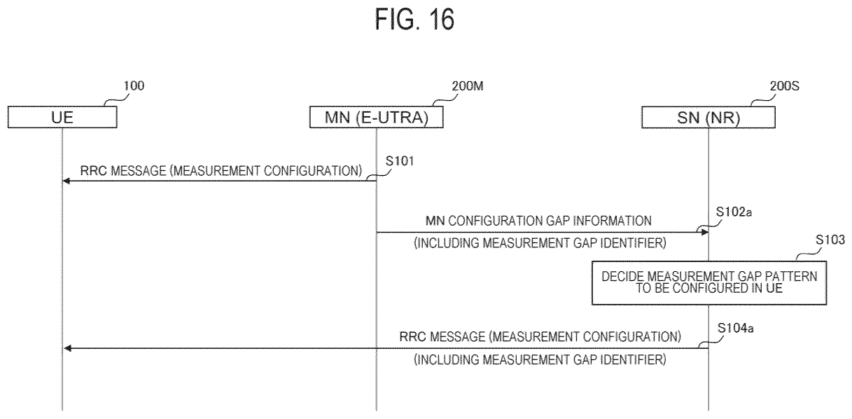

Next, a first modification example of the operation of the mobile communication system 1 will be described with reference to FIG. 16.

In the present modification example, a measurement gap identifier is assigned to each measurement gap pattern. The MN configuration gap information transmitted from the MN 200M to the SN 200S includes the measurement gap identifier of each of a plurality of measurement gap patterns configured in the UE 100 by the MN 200M. Accordingly, the SN 200S can not only detect each measurement gap pattern configured in the UE 100 by the MN 200M, but also detect the measurement gap identifier of the measurement gap pattern.

As described above, the SN 200S (transmitter 211) transmits the RRC message including the information (measurement configuration) for configuring the measurement gap pattern decided by itself to the UE 100. Here, in a case in which the SN 200S configures the measurement gap pattern selected from a plurality of measurement gap patterns configured in the UE 100 by the MN 200M in the UE 100, the SN 200S (transmitter 211) may transmit the RRC message including the measurement gap identifier of the selected measurement gap pattern. That is, in a case in which the SN 200S configures the same measurement gap pattern as the measurement gap pattern configured in the UE 100 by the MN 200M in the UE 100, the SN 200S notifies the UE 100 of the measurement gap identifier of the same measurement gap pattern. Accordingly, in a case in which the SN 200S uses the same configuration as the measurement gap pattern already configured in the UE 100 from the MN 200M, instead of transmitting the actual configuration of the measurement gap pattern, the measurement gap identifier of the measurement gap pattern is transmitted to the UE 100, and thus it is possible to reduce the consumption of radio resources and power.

In the present modification example, an ID space (measurement gap identifier space) of the measurement gap identifier may be divided into the MN 200M and the SN 200S so that the SN 200S can configure its own unique measurement gap identifier. For example, in a case in which the maximum of the number of IDs is 64, 0 to 31 may be specified for the MN 200M, and 32 to 63 may be specified for the SN 200S. As described above, in a case in which the measurement gap identifier space allocable by the SN 200S is provided independently of the measurement gap identifier space allocable by the MN 200M, the SN 200S (controller 230) may allocate the measurement gap identifier from the measurement gap identifier space allocable by the SN 200S. Similarly, in a case in which the measurement gap identifier space allocable by the MN 200M is provided independently of the measurement gap identifier space allocable by the SN 200S, the MN 200M (controller 230) may allocate the measurement gap identifier from the measurement gap identifier space allocable by the MN 200M.

As illustrated in FIG. 16, in step S101, the MN 200M (transmitter 211) transmits the RRC message including the measurement configuration for configuring a plurality of measurement gap patterns to the UE 100.

In step S102a, the MN 200M (network communicator 220) transmits the MN configuration gap information indicating the configuration of each measurement gap pattern configured in the UE 100 in step S101 to the SN 200S via the network interface (specifically, the interface between the base stations). The MN configuration gap information includes the measurement gap identifier of each measurement gap pattern in addition to the configuration content (see FIGS. 14 and 15) of each measurement gap pattern configured in the UE 100 by the MN 200M. The SN 200S (network communicator 220) receives the MN configuration gap information.

In step S103, the SN 200S (controller 230) decides at least one measurement gap pattern, which is configured in the UE 100 by the SN 200S, on the basis of the MN configuration gap information received in step S102a.

For example, the SN 200S (controller 230) may make a decision to configure the measurement gap pattern including the measurement gap with a timing different from that of the measurement gap pattern configured by the MN 200M in the UE 100. In this case, the SN 200S (controller 230) may configure the measurement gap identifier allocated from the measurement gap identifier space allocable by the SN 200S in the UE 100 together with the measurement gap configuration (step S104a).

Alternatively, in a case in which the SN 200S desires to use the measurement gap pattern configured by the MN 200M, the SN 200S (controller 230) may configure the measurement gap identifier of the measurement gap pattern in the UE 100 (step S104a). Here, the SN 200S (controller 230) may associate the measurement gap identifier with the measurement object.

### (Second Modification Example of Operation of Mobile Communication System)

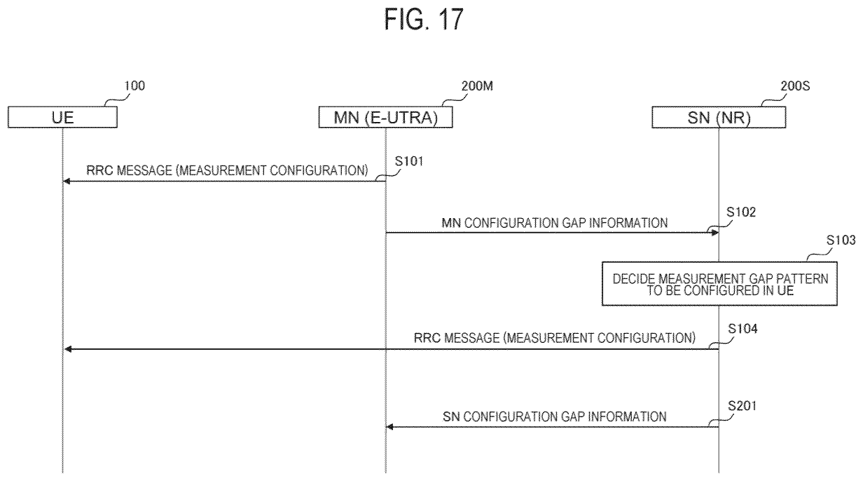

Next, a second modification example of the operation of the mobile communication system 1 will be described with reference to FIG. 17.

In the present modification example, the SN 200S (network communicator 220) transmits the SN configuration gap information indicating the configuration of each of one or a plurality of measurement gap patterns configured in the UE 100 by the SN 200S to the MN 200M via the network interface. The MN 200M (network communicator 220) transmits the SN configuration gap information indicating the configuration of each of one or a plurality of measurement gap patterns configured in the UE 100 by the SN 200S from the SN 200S via the network interface. Accordingly, even in a case in which each of the MN 200M and the SN 200S can configure the measurement gap pattern in the UE 100, the MN 200M can detect and consider each measurement gap pattern configured by the SN 200S. Therefore, the MN 200M can appropriately configure the measurement gap pattern in the UE 100. For example, the MN 200M (controller 230) may perform a process such as not performing data scheduling during the measurement gap of the measurement gap pattern configured by the SN 200S.

As illustrated in FIG. 17, the operations of steps S101 to S104 are similar to those in the above-described embodiment.

In step S201, the SN 200S (network communicator 220) transmits the SN configuration gap information indicating the configuration of each of one or a plurality of measurement gap patterns configured (step S104) in the UE 100 by the SN 200S to the MN 200M via the network interface.

The SN configuration gap information is constituted by an information element included in a message between the base stations transmitted on the interface between the base stations. The message between the base stations may be an acknowledgment message for the SN addition request message, or an SN correction request message for correcting the configuration of the SN 200S after initiating the DC. The information element constituting the SN configuration gap information may be CG-Config which is a type of RRC message between nodes and is used for an SCG configuration request or the like, or may be an information element which is newly introduced into the message between the base stations.

The SN configuration gap information may have a configuration similar to any one of the first configuration example and the second configuration example of the SN configuration gap information described above. For example, the SN 200S (network communicator 220) may transmit the measurement configuration configured in the UE 100 in step S104 to the MN 200M as the SN configuration gap information. Alternatively, the SN 200S (network communicator 220) may transmit the minimum necessary information (see FIG. 15) out of the measurement configuration configured in the UE 100 in step S104 to the MN 200M as the SN configuration gap information.

As described above, according to the present modification example, since the MN 200M can also detect the measurement gap pattern configured by the SN 200S, it is possible to avoid wastage of radio resources or power such as data scheduling performed by the MN 200M when the UE 100 executes the measurement gap pattern for the SN 200S.

### OTHER EMBODIMENTS

In the above-described embodiment, the example using the (NG) EN-DC has been mainly described. However, as long as the scenario in which the SN 200S independently configures the measurement gap pattern in the UE 100 is applied, the present invention is not limited to the (NG) EN-DC, and the present invention may be applied to the DC other than the (NG) EN-DC.

Further, the example in which the MN 200M is the E-UTRA base station has been mainly described, but the MN 200M may be the NR base station. Similarly, the example in which the SN 200S is the NR base station has been mainly described, but the SN 200S may be the E-UTRA base station.

Although the dual connectivity (DC) in which the UE 100 communicates with two base stations has been described in the above embodiment, the UE 100 may establish multiple connection with three or more base stations 200 including two or more SNs 200S, and such multiple connection may also be a form of DC.

The operation sequence (and the operation flow) in the above-described embodiment may not necessarily be executed in time series according to the order described in the flow diagram or the sequence diagram. For example, the steps in the operation may be performed in an order different from the order described in the flowchart or the sequence diagram, or may be performed in parallel. In addition, some of the steps in the operation may be removed or additional steps may be added to the process. Furthermore, the operation sequence (and the operation flow) in the above-described embodiment may be performed separately and independently, or may be performed by combining two or more operation sequences (and operation flows). For example, some steps of one operation flow may be added to other operation flows, or some steps of one operation flow may be replaced with some steps of other operation flows.

In the above-described embodiments, the mobile communication system based on the NR has been mainly described as the mobile communication system 1. However, the mobile communication system 1 is not limited to this example. The mobile communication system 1 may be a system conforming to the TS of any of LTE or other generation systems (for example, sixth generation) of the 3GPP standard. The base station 200 may be an eNB providing protocol terminations of E-UTRA user plane and control plane toward the UE 100 in LTE. The mobile communication system 1 may be a system conforming to a TS defined in a standard other than the 3GPP standard. The base station 200 may be an integrated access and backhaul (IAB) donor or an IAB node.

A program for causing a computer to execute each process performed by the UE 100 or the base station 200 may be provided. The program may be recorded in a computer readable medium. The program may be installed in the computer by using the computer readable medium. Here, the computer readable medium on which the program is recorded may be a non-transitory recording medium. The non-transitory recording medium is not particularly limited, but may be, for example, a recording medium such as a CD-ROM or a DVD-ROM. In addition, a circuit that executes each processing performed by the UE 100 or the base station 200 may be integrated, and at least a part of the UE 100 or the base station 200 may be a semiconductor integrated circuit (chipset, SoC (system-on-a-chip)).

In the above-described embodiment, “transmit (transmit)” may mean to perform processing of at least one layer in a protocol stack used for transmission, or may mean to physically transmit a signal wirelessly or by wire. Alternatively, “transmit” may mean a combination of performing the processing of at least one layer and physically transmitting a signal wirelessly or by wire. Similarly, “receive (receive)” may mean to perform processing of at least one layer in a protocol stack used for reception, or may mean to physically receive a signal wirelessly or by wire. Alternatively, “receive” may mean a combination of performing the processing of at least one layer and physically receiving a signal wirelessly or by wire. Similarly, “acquire (obtain/acquire)” may mean to acquire information from stored information, may mean to acquire information from information received from another node, or may mean to acquire the information by generating information. Similarly, “include (include)” and “comprise (comprise)” do not mean to include only the listed items, but mean that the terms may include only the listed items or may include additional items in addition to the listed items. Similarly, in the present disclosure, “or (or)” does not mean exclusive OR but means OR.

Although the present disclosure has been described in accordance with examples, it is understood that the present disclosure is not limited to the examples and structures. The present disclosure also includes various modifications and modifications within an equivalent range. In addition, various combinations and modes, and other combinations and modes including only one element, more elements, or less elements are also within the scope and idea of the present disclosure.

### SUPPLEMENTARY NOTES

Features related to the above-described embodiments are additionally described.

### Supplementary Note 1

Abase station (200) configured to operate as an MN (200M) in a case of using dual connectivity in which the master node (MN) (200M) and a secondary node (SN) (200S) communicate with a user equipment (UE) (100), the base station (200) comprising:
a controller (230) configured to configure a plurality of measurement gap patterns in the UE (100); and
a network communicator (220) configured to transmit MN configuration gap information indicating a configuration of each of the plurality of measurement gap patterns to the SN (200S) via a network interface.

### Supplementary Note 2

The base station (200) according to supplementary note 1,
wherein the MN (200M) is an evolved universal terrestrial radio access (E-UTRA) base station (200), and the SN (200S) is an NR radio access (NR) base station (200).

### Supplementary Note 3

The base station (200) according to supplementary note 1 or 2, further comprising
a transmitter (211) configured to transmit a radio resource control (RRC) message including a measurement configuration for configuring the plurality of measurement gap patterns to the UE (100),
wherein the network communicator (220) transmits the measurement configuration transmitted to the UE (100) to the SN (200S) as the MN configuration gap information.

### Supplementary Note 4

The base station (200) according to supplementary notes 3,
wherein the network communicator (220) transmits, to the SN (200S) as the MN configuration gap information, configuration information that is information of a part of the measurement configuration transmitted to the UE (100), and dedicated to each of the plurality of measurement gap patterns.

### Supplementary Note 5

The base station (200) according to any one of supplementary notes 1 to 4,
wherein the MN configuration gap information includes a measurement gap identifier of each of the plurality of measurement gap patterns.

### Supplementary Note 6

The base station (200) according to supplementary note 5,
wherein in a case in which a measurement gap identifier space allocable by the MN (200M) is provided independently of the measurement gap identifier space allocable by the SN (200S), the controller (230) allocates the measurement gap identifier from the measurement gap identifier space allocable by the MN (200M).

### Supplementary Note 7

The base station (200) according to any one of supplementary notes 1 to 6,
wherein the network communicator (220) receives SN configuration gap information indicating a configuration of each of one or a plurality of measurement gap patterns configured in the UE (100) by the SN (200S) from the SN (200S) via the network interface.

### Supplementary Note 8

A base station (200) configured to operate as an SN (200S) in a case of using dual connectivity in which a master node (MN) (200M) and the secondary node (SN) (200S) communicate with a user equipment (UE) (100), the base station (200) comprising:
a network communicator (220) configured to receive MN configuration gap information indicating a configuration of each of a plurality of measurement gap patterns configured in the UE (100) by the MN (200M) from the MN (200M) via a network interface; and
a controller (230) configured to decide at least one measurement gap pattern to be configured in the UE (100) by the SN (200S) on the basis of the MN configuration gap information.

### Supplementary Note 9

The base station (200) according to supplementary note 8,
wherein the network communicator (220) receives the measurement configuration transmitted from the MN (200M) to the UE (100) as the MN configuration gap information from the MN (200M).

### Supplementary Note 10

The base station (200) according to supplementary note 9,
wherein the network communicator (220) receives, from the MN (200M) as the MN configuration gap information, configuration information that is information of a part of the measurement configuration transmitted from the MN (200M) to the UE (100), and dedicated to each of the plurality of measurement gap patterns.

### Supplementary Note 11

The base station (200) according to any one of supplementary notes 8 to 10,
wherein the MN configuration gap information includes a measurement gap identifier of each of the plurality of measurement gap patterns configured in the UE (100) by the MN (200M).

### Supplementary Note 12

The base station (200) according to supplementary note 11, further comprising
a transmitter (211) configured to transmit a radio resource control (RRC) message including information for configuring the decided measurement gap pattern to the UE (100),
wherein in a case in which the SN (200S) configures, in the UE (100), a measurement gap pattern selected from the plurality of measurement gap patterns configured in the UE (100) by the MN (200M), the transmitter (211) transmits the RRC message including the measurement gap identifier of the selected measurement gap pattern.

### Supplementary Note 13

The base station (200) according to supplementary note 11 or 12,
wherein in a case in which a measurement gap identifier space allocable by the SN (200S) is provided independently of the measurement gap identifier space allocable by the MN (200M), the controller (230) allocates the measurement gap identifier from the measurement gap identifier space allocable by the SN (200S).

### Supplementary Note 14

The base station (200) according to any one of supplementary notes 8 to 13,
wherein the network communicator (220) transmits SN configuration gap information indicating a configuration of each of one or a plurality of measurement gap patterns configured in the UE (100) by the SN (200S) to the MN (200M) via the network interface.

### Supplementary Note 15

A communication method for a base station (200) configured to operate as an MN (200M) in a case of using dual connectivity in which the master node (MN) (200M) and a secondary node (SN) (200S) communicate with a user equipment (UE) (100), the method comprising the steps of:
configuring a plurality of measurement gap patterns in the UE (100); and
transmitting MN configuration gap information indicating a configuration of each of the plurality of measurement gap patterns to the SN (200S) via a network interface.

### Supplementary Note 16

A communication method for a base station (200) configured to operate as an SN (200S) in a case of using dual connectivity in which a master node (MN) (200M) and the secondary node (SN) (200S) communicate with a user equipment (UE) (100), the method comprising the steps of:
receiving MN configuration gap information indicating a configuration of each of a plurality of measurement gap patterns configured in the UE (100) by the MN (200M) from the MN (200M) via a network interface; and
deciding at least one measurement gap pattern to be configured in the UE (100) by the SN (200S) on the basis of the MN configuration gap information.

1. A base station configured to operate as a master node (MN) connected to a communication apparatus and a secondary node (SN), the base station comprising:
a transmitter configured to transmit, to the communication apparatus, a radio resource control (RRC) message including first information and second information, the first information being used for configuring each of a plurality of measurement gap patterns and including information indicating a length of a measurement gap and information indicating a repetition period of the measurement gap, the second information being used for configuring an identifier of the measurement gap;
a controller configured to include, in a CG-ConfigInfo message, the first information indicating the each of the plurality of the measurement gap patterns configured to the communication apparatus and the second information indicating the identifier of the measurement gap configured to the communication apparatus; and
a network communicator configured to transmit, to the SN, a SN addition request message including the CG-ConfigInfo message.

2. The base station according to claim 1, wherein
the network communicator is configured to transmit, to the SN, a SN modification request including the CG-configInfo message.

3. The base station according to claim 1, wherein
the each of the plurality of the measurement gap patterns are configured for a specific purpose.

4. A communication apparatus that communicates with a base station configured to operate as a master node (MN) connected to a secondary node (SN), the communication apparatus comprising:
a receiver configured to receive, from the base station, a radio resource control (RRC) message including first information and second information, the first information being used for configuring each of a plurality of measurement gap patterns, and including information indicating a length of a measurement gap and information indicating a repetition period of the measurement gap, the second information being used for configuring an identifier of the measurement gap; and
a controller configured to perform a measurement within measurement gaps based on the first information and the second information, wherein
a SN addition request message including a CG-ConfigInfo message is transmitted, by the base station, to the SN, the CG-ConfigInfo message including the first information indicating the each of the plurality of the measurement gap patterns configured to the communication apparatus and the second information indicating the identifier of the measurement gap configured to the communication apparatus.

5. The communication apparatus according to claim 4, wherein
a SN modification request message including the CG-ConfigInfo message is transmitted, by the base station, to the SN.

6. The communication apparatus according to claim 4, wherein
the each of the plurality of the measurement gap patterns are configured for a specific purpose.

7. A communication method for a base station configured to operate as a master node (MN) connected to a communication apparatus and a secondary node (SN), the communication method comprising:
a step of transmitting, to the communication apparatus, a radio resource control (RRC) message including first information and second information, the first information being used for configuring each of a plurality of measurement gap patterns and including information indicating a length of a measurement gap and information indicating a repetition period of the measurement gap, the second information being used for configuring an identifier of the measurement gap;
a step of including, in a CG-ConfigInfo message, the first information indicating the each of the plurality of the measurement gap patterns configured to the communication apparatus and the second information indicating the identifier of the measurement gap configured to the communication apparatus; and
a step of transmitting, to the SN, a SN addition request message including the CG-ConfigInfo message.

8. The communication method according to claim 7, further comprising:
a step of transmitting, to the SN, a SN modification request including the CG-ConfigInfo message.

9. The communication method according to claim 7, wherein
the each of the plurality of the measurement gap patterns are configured for a specific purpose.
